(19) United States
(12) Patent Application Publication
(10) Pub. No.: US 2011/0198201 A1
(43) Pub. Date: Aug. 18, 2011

(54) STEERING WHEEL HAVING A DIRECTION LIGHT BUTTON

(76) Inventor: Chih-Kai CHUANG, Taichung City (TW)

(21) Appl. No.: 12/704,994

(22) Filed: Feb. 12, 2010

(51) Int. Cl. H01H 13/00

(52) U.S. Cl. 200/61.54

(57) ABSTRACT

A steering wheel having a direction light button includes a steering wheel and a direction light control button disposed at a predetermined position of the steering wheel. The direction light control button includes at least one left turn button and at least one right turn button. When the driver wants to take a turn, the driver can operate the direction light control button disposed on the steeling wheel with his/her hands, avoiding any wrong operation of direction lights.

### BACKGROUND OF THE INVENTION

1. Field of the Invention

The present invention relates to a steering wheel, and more particularly to a steering wheel having a direction light button.

2. Description of the Prior Art

As shown in FIG. 1, a conventional automobile steering wheel comprises a lever 10 located at the left side of a steering wheel 11. When the driver wants to take a turn, the lever 10 is pushed upward to indicate a right turn or the lever 10 is pushed downward to indicate a left turn. The end of the lever 10 is provided with a rotatable switch 101 which is used to turn on/off the headlight of the automobile. When in use, the driver has to move his/her left hand to control the operation of the lever 10. Besides, the up and down movements of the lever 10 don't direct correspond to the left and right turnings, which can't be operated by intuition. In addition, the rotatable switch 101 of the lever 10 may be operated wrongly to turn on the headlight when the driver wants to take a turn.

### SUMMARY OF THE INVENTION

The present invention is to provide a steering wheel having a direction light button, which comprises a steering wheel and a direction light control button disposed at a predetermined position of the steering wheel. The direction light control button includes at least one left turn button and at least one right turn button. When the driver wants to take a turn, the driver can operate the direction light control button disposed on the steeling wheel with his/her hands. This is very handy for the driver to take a turn. The left turn button and the right turn button of the direction light control button can be operated by intuition, avoiding any wrong operation.

### BRIEF DESCRIPTION OF THE DRAWINGS

FIG. 1 is a schematic view showing the operation of a conventional steering wheel;

FIG. 2 is a perspective view according to a first embodiment of the present invention;

FIG. 3 is a schematic view showing the recovery device according to the first embodiment of the present invention;

FIG. 4 is a circuit flow chart according to the first embodiment of the present invention;

FIG. 5 is a schematic view showing signals of the recovery device according to the first embodiment of the present invention;

FIG. 6 is a perspective view according to a second embodiment of the present invention;

FIG. 7 is a perspective view according to a third embodiment of the present invention; and

FIG. 8 is a perspective view according to a fourth embodiment of the present invention.

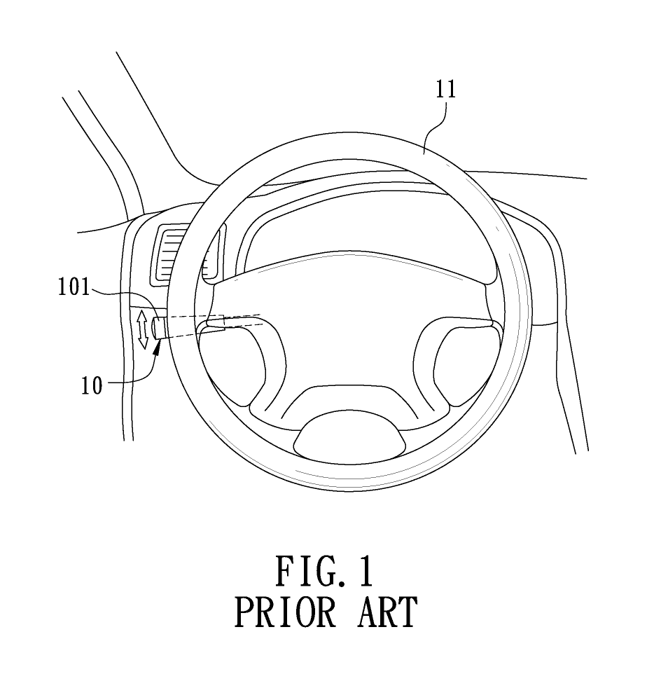

### DETAILED DESCRIPTION OF THE PREFERRED EMBODIMENTS

Embodiments of the present invention will now be described, by way of example only, with reference to the accompanying drawings.

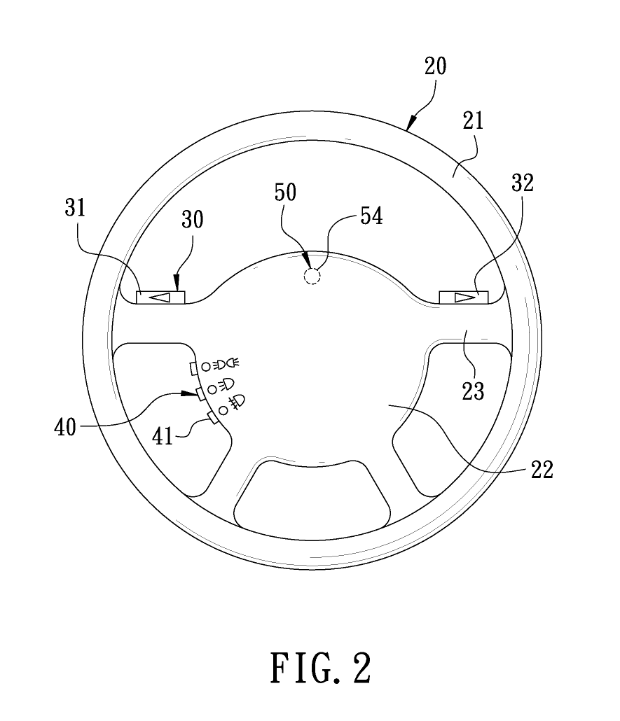

As shown in FIG. 2, a first embodiment of the present invention comprises a steering wheel 20, a direction light control button 30, a headlight control button 40, and a recovery device 50.

The steering wheel 20 includes a circular grasp portion 21, a central portion 22 and a connection portion 23 which is connected between the central portion 22 and the grasp portion 21.

The direction light control button 30 includes a left turn button 31 and a right turn button 32. In this embodiment, the left turn button 31 and the right turn button 32 are mechanical buttons, which can by touch buttons, knobs or the like. The left turn button 31 and the right turn button 32 are respectively located at two sides of the grasp portion 21 of the steering wheel 20 close to the connection portion 23.

The headlight control button 40 is located at one side of the central portion 22 of the steering wheel 20 or at any desired position of the steering wheel 20. The headlight control button 40 is composed of three press buttons 41 to elect a switch mode.

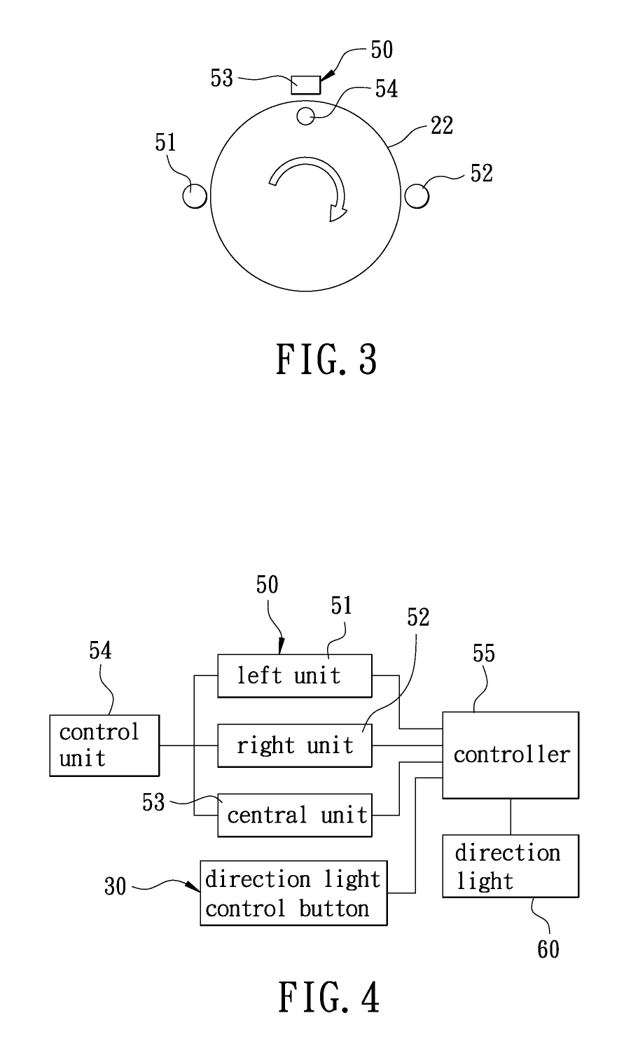

The recovery device 50, referring to FIGS. 3 and 4, includes a left unit 51, a right unit 52 and a central unit 53 which are located under the central portion 22 of the steering wheel 20, a control unit 54 which is located on a bottom of the central portion 22, and a controller 55.

In order to understand the features of the present invention, the technical means of application, and anticipated effects, the use of the present invention is described hereinafter.

Referring to FIG. 2, when taking a right turn, the driver presses the right turn button 32 with his/her right hand to actuate a direction light 60. At this time, the driver's hands are still on the steering wheel 20 for ensuring driving safety. Besides, when taking a right turn, to press the right turn button 32 by intuition can avoid any wrong operation.

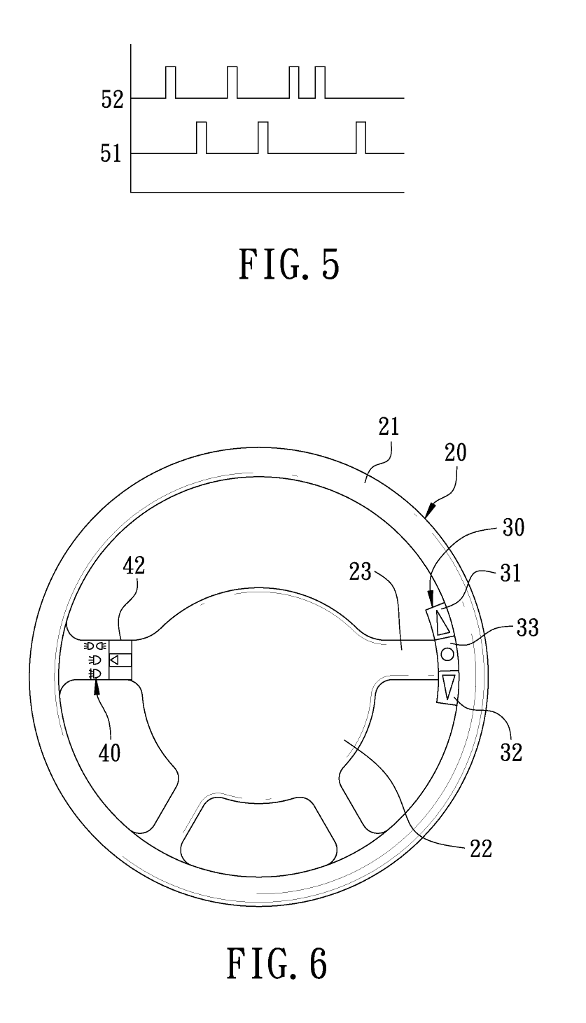

Furthermore, referring to FIGS. 3 to 5, when the right turn button 32 is pressed, the control unit 54 on the bottom of the steering wheel 20 will touch off the right unit 52, the left unit 51, and then the right unit 52 in sequence. After the turning is achieved, the steering wheel 20 will bring a recovery motion for a straight route. This moment, the control unit 54 will touch off the right unit 52 again to know that the car has made a direction change. When the control unit 54 and the central unit 53 are overlapped, the central unit 53 will actuate the controller 55 to stop the operation of the direction light 60. The central unit 53 can be omitted. Only the control unit 54 and the left unit 51/the right unit 52 are required to touch off repeatedly for knowing the change of direction, such that the controller 55 stops the operation of the direction light 60.

In addition, the press buttons 41 of the headlight control button 40 are located at the side of the central portion 22 of the steering wheel 20, which are separated from the direction light control button 30 for avoiding any wrong operation. The driver's hands are able to control the headlight control button 40, without leaving the steering wheel 20.

FIG. 6 is a perspective view according to a second embodiment of the present invention, which is substantially similar to the first embodiment with the exceptions described hereinafter. The left turn button 31 and the right turn button 32 of the direction light control button 30 are located at the same side of the steering wheel 20. A stop button 33 is provided between the left turn button 31 and the right turn button 32. The driver can operate the direction light control button 30 with one single hand. When the driver wants to stop the direction light 60, he/she can direct press the stop button 33 or the original preset button. Besides, the headlight control button 40 is located on the connection portion 23, which uses a changeover switch 42 to control the operation.

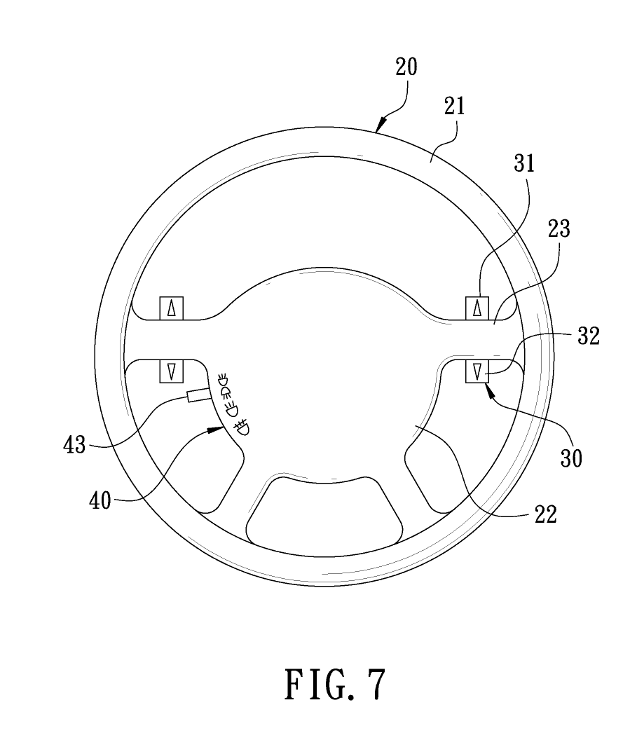

FIG. 7 is a perspective view according to a third embodiment of the present invention, which is substantially similar to the first embodiment with the exceptions described hereinafter. Two pairs of direction light control buttons 30 are provided under two sides of the connection portion 23 of the steering wheel 20. Each pair of the direction light control buttons 30 includes a left turn button 31 and a right turn button 32. The headlight control button 40 is located at one side of the central portion 22, which uses a lever switch 43 to control the operation.

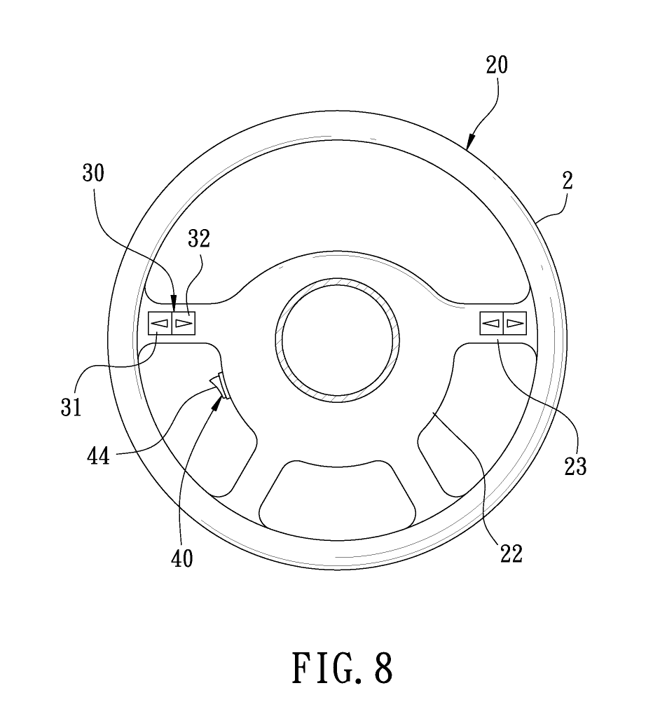

FIG. 8 is a perspective view according to a fourth embodiment of the present invention, which is substantially similar to the first embodiment with the exceptions described hereinafter. Two pairs of direction light control buttons 30 are provided on the back of two sides of the connection portion 23 of the steering wheel 20. Each pair of the direction light control buttons 30 includes a left turn button 31 and a right turn button 32. The headlight control button 40 is located at one side of the central portion 22, which uses a press switch 44 to control the operation.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A steering wheel having a direction light button, comprising:
a steering wheel;
a direction light control button disposed at a predetermined position of the steering wheel, the direction light control button including at least one left turn button and at least one right turn button; and
a direction light electrically connected to the direction light control button.

2. The steering wheel having a direction light button as claimed in claim 1, wherein the steering wheel including a circular grasp portion, a central portion and a connection portion which is connected between the central portion and the grasp portion, the left turn button and the right turn button being respectively located at left and right sides of the grasp portion of the steering wheel with the central portion to be an axle center.

3. The steering wheel having a direction light button as claimed in claim 1, wherein the left turn button and the right turn button of the direction light control button are mounted on the steering wheel.

4. The steering wheel having a direction light button as claimed in claim 1, further comprising a recovery device, the recovery device being adapted to switch off the direction light.

5. The steering wheel having a direction light button as claimed in claim 4, wherein the recovery device includes a left unit, a right unit, a control unit, and a controller, the control unit being disposed on the steering wheel to touch off the left unit and the right unit, the left unit and the right unit being respectively located at left and right sides of the steering wheel, the left unit and the right unit being connected with the controller, the controller being electrically connected with the direction light control button and the direction light.

6. The steering wheel having a direction light button as claimed in claim 1, wherein the steering wheel is provided with a headlight control button.

7. The steering wheel having a direction light button as claimed in claim 6, wherein the headlight control button is selected from one of the group consisting of a press button, a changeover switch, a lever switch, and a press switch.

8. The steering wheel having a direction light button as claimed in claim 1, wherein the left turn button and the right turn button of the direction light control button are selected from one of the group consisting of a mechanical button, a touch button, and a knob.

9. The steering wheel having a direction light button as claimed in claim 1, wherein the direction light control button further comprises a stop button.
